(19) United States
(12) Patent Application Publication
(10) Pub. No.: US 2009/0044422 A1
(43) Pub. Date: Feb. 19, 2009

(54) Method for detecting volatile, flammable substances in a dryer and a dryer suitable for this purpose

(75) Inventors: Harald Moschuetz, Grossbeeren (DE); Ulrich Nehring, Berlin (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/221,593

(22) Filed: Aug. 4, 2008

(30) Foreign Application Priority Data
Aug. 14, 2007 (DE) 10 2007 038 369.1
Aug. 30, 2007 (DE) 10 2007 041 066.4

(51) Int. Cl. D06F 58/28; G01J 5/02

(52) U.S. Cl. 34/544; 250/339.1; 250/339.11

(57) ABSTRACT

A method for detecting a volatile, flammable substance during drying of moist textiles in a dryer with a drum for receiving includes irradiating the textiles or their environment with infrared radiation, receiving infrared radiation from the textiles or their environment in a wavelength range of 600 to 4000 cm-1, and evaluating the received infrared radiation.

### BACKGROUND OF THE INVENTION

1. Field of the Invention

The invention relates to a method for detecting volatile, flammable substances when drying water-moistened textiles in a dryer and to a dryer suitable for this purpose. In particular the invention relates to such a method for detecting volatile, flammable substances in a dryer which employs electromagnetic radiation in the IR wavelength range, as well as to a dryer suitable for this purpose.

2. Related Art

Volatile, easily flammable substances should not get into a dryer, especially a dryer for use in a normal household. Such substances are frequently hydrocarbons, such as benzene-based cleaners, alcohols etc. Indeed the use of such substances in the dryer is explicitly forbidden by a warning given in the operating instructions. It is however occurring even more frequently, as a result of careless use of flammable solvents, especially cleaning benzene, that cleaned textiles or textiles containing for any other reason volatile, easily-flammable substances are put into a dryer to dry them.

The use of an IR sensor for detection of textile type, fill level and volume of water in the drum of a washing machine or of a dryer is known.

EP 0 816 551 B1 discloses infrared temperature detection for control of a dryer, especially a dryer with a rotating drum for accepting and tumbling moist articles to be dried, a heating device for heating up the articles, a blower unit for passing air over the articles in the drum and an infrared detection unit which makes available a control signal corresponding to the temperature of the articles in the drum. A method for recording the completeness of a drying process in a dryer with a rotating drum and an infrared detection device is disclosed which provides a measurement of the temperature of the articles in the drum.

EP 1242665 B1 discloses a device for handling textiles with an evaluation circuit for detection of the type of textile and/or moisture of an item of washing. The device uses transmit and receive elements for transmitting or receiving electromagnetic radiation as well as an evaluation circuit connected to the receive element. Also described is a method for detection of characteristics of a textile item for example in a washing machine or a dryer.

U.S. Pat. No. 5,739,534 describes methods and devices for detecting liquids, with the water level being measured with an IR sensor.

U.S. Pat. No. 5,396,715 describes a microwave tumble dryer and a method with fire protection which uses an IR sensor to detect the temperature within the drum and, on reaching a predetermined value which indicates that washing would be burned, interrupting the operation of the tumble dryer.

Drums with IR sensor devices for measurement of the temperature in tumble dryers are also known from JP-A-06-126099, JP-A-07-178293 and JP-A-05-200194. The use of an IR turbidity sensor is described in JP-A-06-039189.

US 2002/0004995 A1 relates to system for checking drying cycles in a dryer device which contains the vapor of a lipophilic liquid, with a gas sensor being used for determining its concentration.

The use of an infrared sensor is known in DE 44 25 742 C1, in a method for drying textiles which were washed with a non-aqueous, especially organic and combustible solvent, for determining a concentration of the solvent in a circulating air stream used for drying. A sensor used for this purpose is very difficult to handle however; In particular it requires technical support from specially trained personnel. The method is thus not suitable for use in a household tumble dryer, for which ongoing technical support is out of the question.

EP 0 929 803 B1 describes an optical sensor for detection of chemical substances dissolved or dispersed in water, which includes as its sensor element an optically transparent substrate and a thin-film polymer layer.

Different fabrics and volatile, flammable substances can be differentiated from each other by an analysis, as is known for example from the book “Erkennen von Kunststoffen—Qualitative Kunststoffanalyse mit einfachen Mitteln” (Recognition of Plastics—Qualitative plastics analysis with simple means”) by Dietrich Braun, 1998, 3rd Edition. The wavelength range of 1500 nm to 1800 nm is especially suitable because of its independence from moisture.

### SUMMARY OF THE INVENTION

The object of the invention is thus to provide method for detecting volatile, flammable substances in a dryer as well as a dryer suitable for this purpose.

The subject matter of the invention is thus a method for detecting volatile, flammable substances during drying of moist textiles in a dryer with a drum for receiving the textiles and a transmit element which irradiates the textiles and/or their surroundings with IR radiation, with a receive element which receives the IR radiation reflected from the textiles and/or the walls of the drum and/or the transmitted IR radiation in the wavenumber range of 600 to 4000 cm-1 and evaluates it in respect of the presence of volatile, flammable substances.

The subject matter of the invention is additionally a dryer with a drum for receiving the textiles and a transmit element and a receive element for detecting volatile, flammable substances during drying of moist textiles, with said transmit element being configured to irradiate the textiles and/or their surroundings with IR radiation, and with said receive element being configured to receive the IR radiation reflected from the textiles and/or the walls of the drum and/or the transmitted IR radiation in the wavenumber range of 600 to 4000 cm-1 and with said dryer being configured to evaluate the received IR radiation in respect of the presence of volatile, flammable substances.

### BRIEF DESCRIPTION OF THE DRAWINGS

FIG. 1 is a schematic view of a dryer 1 in accordance with an exemplary embodiment of the present invention.

### DETAILED DESCRIPTION

Volatile, flammable substances within the meaning of the invention are for example Hydrocarbons such as for example: Alkanes; alkenes; alkynes and aromatics; alcohols such as ethane, methane, propane, isopropanol; ethers such as dimethyl ether, diethyl ether; carboxylic acids such as acetic acid, butyric acid; esters such as acetic acid ethylester, aldehydes such as formaldehyde and ketones such as acetone; as well as amines; nitrites; nitro compounds; heterocyclic compounds; sulfur compounds; etc., which can be present at temperatures of 50° C. and normal pressure at least partly in gaseous form.

In accordance with the invention electromagnetic radiation in the IR range (wavenumbers of 600 to 4000 cm-1) is used to determine the presence of volatile, flammable substances in a dryer. If substances are exposed to a radiation source which radiates radiation in this wavenumber range, characteristic spectrums are created for the respective substance. These can be detected by a suitable analysis and be assigned to the different substances. By comparing the recorded spectrums the presence of volatile, flammable substances can thus be established.

Transmit element and receive element together form an IR sensor. These parts can be arranged at a greater or lesser distance from each other in the dryer and for example be arranged so close as to form one IR sensor unit.

The IR sensor unit (or its transmit unit and receive unit components) is preferably arranged so that its field of vision detects a maximum surface of the textiles present in the dryer. For example the IR sensor unit can be mounted along the axis of rotation of the drum. With such an embodiment the sensor unit can be accommodated directly on the door of the dryer, through which the textiles are inserted into the dryer, by for example replacing a part of the door of the dryer by a panel containing the IR sensor. It is however also possible for the sensor to be fitted along other regions of the dryer, which makes it possible to see the inside of the drum and the textiles present within it.

The IR sensor used is preferably highly capable of resisting vibrations and high temperatures.

A transmit element as defined by the invention is any radiator transmitting electromagnetic radiation in the IR range, meaning for example an incandescent lamp, halogen lamp, mercury vapor lamp, LED and laser diode. Especially suitable are transmit elements which create a narrowband spectrum or IR radiation of one wavelength. Monochromatic or narrowband transmit elements in conjunction with one or more receive elements are suitable, with these being able to be wideband provided they only include the bandwidth of the IR radiation transmitted by the transmit element. Alternatively wideband transmit elements and assigned wavelength-selective receive elements can be used. Instead of wavelength-selective receive elements wideband transmit elements and/or receive elements can also be used, if either the transmit elements or the receive elements are assigned narrowband filters. Preferably a plurality of IR transmit elements is used, with these creating either different spectrums or monochromatic light of different IR wavenumbers. Accordingly the (IR) receive elements are adapted to the transmit elements, with these either detecting a certain band within the transmit radiation radiated by the transmit element or detecting precisely the wavelength which the transmit element transmits, provided these are monochromatic IR radiation sources. Thus photo diodes or photo transistors, which can be used individually or in multiples, are especially suitable as receive elements. Provided the transmit element IR emits radiation in a number of wavenumber ranges, a plurality of IR receive elements, especially photo diodes with an upstream filter or grid, or a photo diode array or CCDs (“Charge Coupled Devices”) are preferably used, which absorb IR radiation and create corresponding signals which are preferably amplified and fed to an evaluation circuit. The received IR radiation is preferably selected according to wavenumbers, which is optionally done by means of a filter, a prism or a diffraction grid.

In the presence of volatile, flammable substances the IR radiation emitted by the transmit element is in part absorbed, but also in part however reflected or transmitted. In this case reflected IR light is primarily suited for detection.

On the basis of the spectrums or wavelengths from a transmitted spectrum reflected by the textiles wetted with volatile, flammable substances or wavelengths a conclusion can be drawn about the type of these substances. This likewise applies to the transmission spectrums. In such cases the spectrums are either evaluated over a specific spectral range or only at specific frequencies or wavelengths in the IR range.

For the inventive method it is preferred that the IR radiation received in the range of 600 to 4000 cm-1 is fed to an evaluation circuit. The evaluation circuit obtains from the received measured values of the IR radiation a signal which preferably warns the user visually or audibly of the presence of volatile, flammable substances. In this case, preferably using the evaluation circuit, information about the type of combustible substances, for example a hydrocarbon compound, such as butane, pentane or an alcohol such as ethanol, n-propanol and isopropanol is provided from the received IR radiation. Preferably the evaluation circuit is set in this case so that the visual or audible signal is output above a specific, preset concentration. Inventively it is thus preferred that when a specific threshold value for the concentration of one or more volatile, flammable substances is exceeded, an audible or visual signal is given.

As a result the heating program can then be prevented from starting or a heating program already started can be ended.

Electromagnetic IR radiation with wavenumbers of 600 to 4000 cm-1 is suitable for the inventive method. Within this range of wavenumbers molecular vibrations can be imparted to volatile, flammable substances by means external energy. Depending on its chemical composition this (as a rule organic) substance absorbs corresponding spectral components from the electromagnetic IR radiation emitting it or reflects this and/or transmits this. The energy is preferably coupled into the substances by means of a wideband emitter, for example an incandescent lamp, a halogen lamp or a light emitting diode, but other narrowband emitters are also suitable.

Inventively the wavenumber range of 1080 to 1300 cm-1 is preferably used for detecting alcohols, ethers, carbonic acids and/or esters. In a similar manner the wavenumber range from 1350 to 1470 cm-1 and the wavenumber range of 2850 to 2960 cm-1 are preferably used for detecting alkanes. For detecting aldehydenes, ketones, carbonic acids and/or esters, the wave number range of 1690 to 1760 cm-1 is preferably used.

Transmit and receive elements can be used at different positions within or outside the drum. Advantageously the receive element is arranged in the roof area in a dryer. Likewise a transmit element can also be arranged there, with a lamp provided for illuminating the inside of the drum of the dryer also being suitable as the transmit element. If this lamp is a halogen lamp or another wideband emitter, it is already suitable as a transmit element. To exclude possible foreign light influences, the light emitted from the transmit element can be modulated in a specific manner and the reflected or emitted light only then used if it exhibits the same modulation.

Transmit and receive elements are preferably used in connection with optical devices, especially focusing lenses, optical waveguides and also optical and/or electrical circuit arrangements for amplification of optical or electrical signals. Advantageously filters can be used to select narrowband spectral ranges. Diffraction gratings which are transparent at different angles for different IR wave numbers, prisms, holographic filters, gratings and similar are suitable as filters for example. Especially suitable also are graduated filters from which incident wideband light is coupled out at different points. Preferably optical waveguides are also used which allow transmit and receive elements to be arranged at a location within the dryer subjected to only slight mechanical stresses and to decouple the IR radiation in the area in which the textiles are present, via an optical waveguide and/or to direct it out of this area via an optical waveguide to the receive element.

The inventive method is generally used to detect of volatile, flammable substances before the start of a heating program or in a starting phase of a heating program, in which the temperature is still relatively low.

However the use of optical waveguides has the advantage that high temperatures which are used in the drying of textiles do not influence the optical elements, such as the transmit and receive elements for example as well as the optical media assigned to them, so that no measures are necessary to compensate for temperature fluctuations at the transmit and/or receive elements. The advantage of this is also that low-cost transmit and/or receive elements can be used which impose lower demands on the temperature stability. The same advantage also relates to the use of control and evaluation electronics assigned to the respective transmit and receive elements.

However the inventive method does not exclude the possibility of the evaluation circuit which includes the transmit and receive elements being arranged directly in the drying area of the textiles.

Preferably the transmit and receive elements are protected from any contamination occurring within the dryer in the form of fluff and dust by a stream of air being blown over the transmit or receive elements. Within a dryer the process air or an air stream supplied from outside, which washes around the process air for example in the counterflow process, is suitable for this. In this method ambient air or process air cleaned by a filter is initially blown past the transmit and receive elements and is then blown into the drum.

Preferably a glass screen is also provided which screens off transmit and/or receive elements from the inner chamber of the dryer and can preferably be taken out by the user for cleaning.

Preferably an automatic synchronization is also undertaken between a send signal and a receive signal in the absence of textiles to be dried, so that faults as a result of contaminants within the dryer, i.e. especially on glass screening the transmit and receive elements, can be subtracted in the subsequent measurement when textiles are present as difference signals from the signals measured at this point. The transmit and/or receive elements can be calibrated for example in each case when the dryer is switched on.

The textiles as well as the water and volatile, flammable substances contained therein absorb energy from the electromagnetic radiation over the entire received IR range. The non-absorbed light is reflected and/or transmitted, with a part of this light being transmitted by means of the receive element to the evaluation circuit. A spectral decomposition of the received spectrum is preferably undertaken there, for example through Fourier transformation of the spectrum (FTIR). In this decomposition the electromagnetic signals are received by means of one or more filters at the receive elements which are embodied for example by individual receive diodes or individual photo transistors or by receive elements arranged in the form of a CCD array. Instead of the filters located in front of the receive elements diffraction gratings can also be provided.

Preferably coupling-in optics are provided which, as well as a grating or a filter, also include a lens system, for example a collecting lens.

The IR wavenumber ranges which actually have to be used or hidden for the receive elements depend on the volatile, flammable substances to be detected. Accordingly narrowband receive elements can be provided which absorb specifically in the wavenumber ranges for these flammable substances, in order to thereby allow an analysis of the chemical composition and the concentration of the substances.

Since the moisture content of a textile item influences its absorption and/or transmission spectrum in a specific wavenumber range, for the measurement of the moisture, of the textile type which may have to be considered and the type of volatile, flammable substances, preferably wavenumber ranges will be selected in which either no such influencing is present or the influence of the mutual distinguishability of volatile, flammable substances and textiles is slight.

Alternatively information which takes account of the dependency of the spectrum of a textile item on the moisture accepted is stored in a memory unit assigned to the evaluation circuit, in order to correct spectral measurements in accordance with the desired data (about the type of the textiles or about their moisture content).

In the evaluation of the spectrums for example the rise and height of the peaks, the height ratio of different peaks and derivation functions from the spectrums can be included.

In an especially preferred embodiment of the invention the evaluation unit includes a memory unit with the spectrums for different flammable substances.

An exemplary embodiment of the invention is illustrated below on the basis of a dryer equipped for execution of the method.

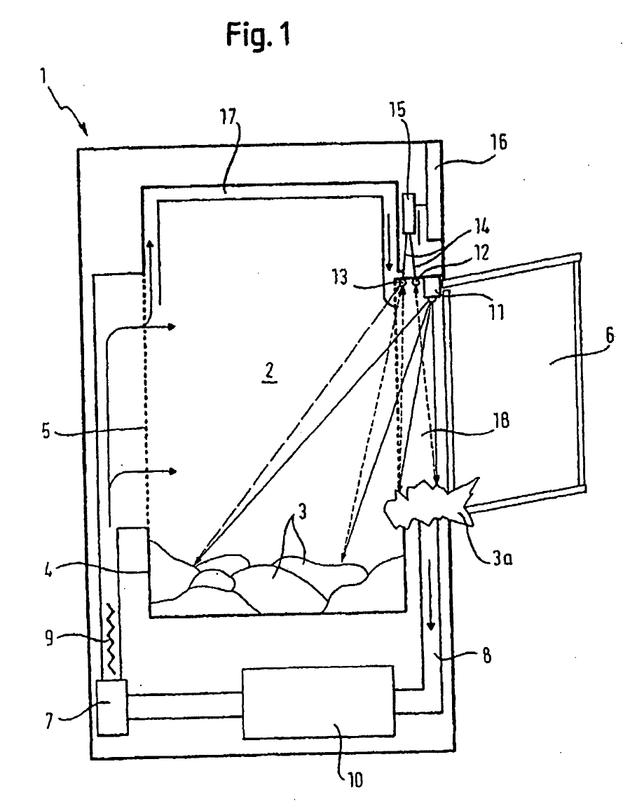

The dryer 1 shown in FIG. 1 is a condenser tumble dryer 1 with rotatably supported drum 2 for receiving the textiles 3 to be dried. The drum 2 has a base 4 with a central hole 5 which is used for filtering a process air stream. On the side lying opposite the base 4 there is an opening able to be sealed off by a door 6. During operation a fan 7 creates the process air stream which then flows through a circuit 8 to a heating device 9 for heating up the process air and subsequently through the central hole 5 of the base 4 into the drum 2.

After contact with the textiles 3, the process air flows through the door 6 which has openings on its inner side and its lower side, through a further section of the recirculation circuit 8 to a condenser 10, in which the process air is cooled off to condense moisture. To this end the condenser 10 has a stream of cold air passing through it which is sucked in from the surroundings of the dryer 1. Beyond the condenser 10 the process air is sucked back in by the fan 7. In the area of the door 6 a lamp 11 is provided, which for example is a wideband emitter, especially an incandescent bulb, a halogen lamp or a light-emitting diode. This emits IR radiation in the direction of the textiles 3 to be dried within the drum 2. In accordance with the type of textiles 3, the moisture of the washing 3 as well as the possible presence of volatile, flammable substances, a part of the IR radiation is reflected, with a certain part of the reflected IR radiation reaching receive elements 12, 13 which are sensitive in different IR wavenumber ranges. Arranging a filter on the radiation input side of the receive elements 12, 13 enables the result to be achieved of only a specific narrow band or only a specific wavenumber being able to be received by the respective receive element 12, 13. In such cases the wavenumber ranges in which the receive elements 12, 13 are sensitive can be suitably selected, that for example the receive elements 12 is sensitive in a specific wavenumber range and detects different chemical substances.

In an evaluation circuit 15 further functions such as for example the derivation function dA/dk (K=absorption, k=wave number) or higher derivations can be determined from the received IR spectrums, which allows maxima, minima, rises and turning points of the IR spectrums to be obtained.

Different fabrics and volatile, flammable substances can be differentiated from each other by an analysis, as is known for example from the book “Erkennen von Kunststoffen—Qualitative Kunststoffanalyse mit einfachen Mitteln” (“Recognition of Plastics—Qualitative plastics analysis with simple means”) by Dietrich Braun, 1998, 3rd Edition. The wavelength range of 1500 nm to 1800 nm is especially suitable because of its independence from moisture.

Transmission spectrums can be executed with a receive element which is arranged below the textiles loaded into the drum 2 or on the lower side of the fill opening, so that this, if the transmit element 11 emits IR radiation, receives the IR radiation let through by the textiles.

The receive elements 12, 13 are connected via lines 14 with the evaluation circuit 15. The evaluation circuit 15 includes evaluation electronics, on the basis of which the spectrums of the textiles, of the volatile, flammable substances or especially relevant parts in the spectrums can be detected. Preferably the evaluation circuit 15 is also assigned a memory, in which known spectrums are stored, so that the evaluation unit 15, by comparing the received spectrums with the stored spectrums, can safely detect and distinguish textiles and volatile, flammable substances. The evaluation circuit 15 thus has access to the memory of the control circuit 16 in order to compare and evaluate spectrums.

If the evaluation circuit 15 detects a spectrum of a volatile, flammable substance, it can influence the further execution of the program and for example create a visual, optical or audibly perceptible signal. This can be controlled so that an alarm signal is initiated above a specific concentration.

In order to always guarantee during the operation of the dryer 1 a good coupling-in of light to the receive elements 12, 13 as well as a trouble-free emission of light from the transmit element 10, a part of the air flow is diverted for this purpose via a specially provided flow channel 17, so that it flows past the receive elements 12, 13 as well as the transmit element 10 and keeps it free from contamination. Alternatively air from outside can also be used for cleaning. Likewise the circulating air, especially also in the counterflow process, can be used. In this case, after passing a filter the cleaned ambient air or process air is blown into the drum 2 from the direction of the receive elements 12, 13 and of the transmit element 10.

In accordance with the invention a method for detecting volatile, flammable substances is provided. If danger threatens, the device can issue a “visual or audible—warning signal or the device automatically undertakes a program correction by not starting or by aborting a selected program. This enables an overheating, a fire or damage to textiles from the effects of the volatile, flammable substances at increased temperatures to be avoided.

The invention has numerous advantages. The detection of substances which are combustible and injurious to health is independent of the user. In addition an increased level of safety in relation to fire and explosions when contaminated textiles are loaded into the device can be implemented.

1. A method for detecting a volatile, flammable substance during drying of moist textiles in a dryer with a drum for receiving the textiles, the method comprising:
irradiating the textiles or their environment with infrared radiation;
receiving infrared radiation from the textiles or their environment in a wavelength range of 600 to 4000 cm-1; and
evaluating the received infrared radiation.

2. The method of claim 1, wherein an evaluation circuit performs said evaluating.

3. The method of claim 1, wherein said evaluating determines the presence of alcohols, ethers, carbonic acids, or esters from a wavelength range of 1080 to 1300 cm-1.

4. The method of claim 1, wherein said evaluating determines the presence of alkanes from a wavelength range of 1350 to 1470 cm-1 and 2850 to 2960 cm-1.

5. The method of claim 1, wherein said evaluating determines the presence of aldehydes, ketones, carbonic acids, or esters from a wavelength range of 1690 to 1760 cm-1.

6. The method of claim 1, further comprising:
determining whether a concentration of a volatile, flammable substance exceeds a threshold; and
issuing an audible or visual signal if it is determined that a concentration of a volatile, flammable substance exceeds a threshold.

7. A dryer, comprising:
a drum for receiving moist textiles;
a transmitter that irradiates the textiles or their environment with infrared radiation with radiation having a wavelength range of 600 to 4000 cm-1;
a receiver that receives infrared radiation reflected from the textiles or a wall of the drum; and
an evaluator that evaluates the infrared radiation received by the receiver to determine whether a volatile, flammable substance is present.
